(19) United States
(12) Patent Application Publication
(10) Pub. No.: US 2013/0231035 A1
(43) Pub. Date: Sep. 5, 2013

(54) ACTIVE AIR FLOW CONTROL IN AIRCRAFT

(71) Applicants: DON DESMARAIS, Westfield, MA (US); JOHN M. MALJANIAN, JR., Farmington, CT (US)

(72) Inventors: DON DESMARAIS, Westfield, MA (US); JOHN M. MALJANIAN, JR., Farmington, CT (US)

(73) Assignee: HAMILTON SUNDSTRAND CORPORATION, Windsor Locks, CT (US)

(21) Appl. No.: 13/409,635

(22) Filed: Mar. 1, 2012

(51) Int. Cl. B64D 13/00; B60H 1/24

(52) U.S. Cl. 454/75; 454/76

(57) ABSTRACT

An active airflow control system for an aircraft includes an air conditioning system, an air conditioning controller configured to control operation of the air conditioning system, a plurality of flow control devices in fluid communication with the air conditioning system and in signal communication with the air conditioning controller, wherein the plurality of flow control devices are configured to increase and decrease an amount of air flowing therethrough in response to receiving a controlling signal from the air conditioning controller, and a plurality of zones in fluid communication with the air conditioning system, wherein each zone of the plurality of zones is a pressurized zone of the aircraft, and wherein each zone of the plurality of zones is in fluid communication with at least one flow control device of the plurality of flow control devices.

### BACKGROUND OF THE INVENTION

The present invention is directed to air flow in aircraft, and more particularly, exemplary embodiments of the present invention are directed to active air flow control in aircraft.

Conventional aircraft ventilation and air conditioning systems are disposed to control total ventilation airflow into a passenger cabin and a cockpit through modulation of an auxiliary power unit powering the air conditioning systems. However, aircraft passenger cabins may be divided into a plurality of different zones. These zones may each have a particular airflow requirement which is not easily addressed through manipulation of total ventilation airflow and modulation of the entire power unit.

### BRIEF DESCRIPTION OF THE INVENTION

According to an exemplary embodiment of the present invention, an active airflow control system for an aircraft includes an air conditioning system, an air conditioning controller configured to control operation of the air conditioning system, a plurality of flow control devices in fluid communication with the air conditioning system and in signal communication with the air conditioning controller, and a plurality of zones in fluid communication with the air conditioning system. The plurality of flow control devices are configured to increase and decrease an amount of air flowing therethrough in response to receiving a controlling signal from the air conditioning controller. Furthermore, each zone of the plurality of zones is a pressurized zone of the aircraft, and each zone of the plurality of zones is in fluid communication with at least one flow control device of the plurality of flow control devices.

According to yet another exemplary embodiment of the present invention, a method of active airflow control in an aircraft includes initializing airflow to a plurality of zones in an aircraft. The initializing of the airflow includes initializing a plurality of flow control devices in fluid communication with each zone of the plurality of zones. The method further includes determining if a change in airflow is required in at least one zone of the plurality of zones, determining airflow requirements for each zone of the plurality of zones responsive to determining a change in airflow is required for the at least one zone, and adjusting the plurality of flow control devices to match or exceed the airflow requirements.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a system of active airflow control for an aircraft, according to an exemplary embodiment of the present invention;

FIG. 2 is another system of active airflow control for an aircraft, according to an exemplary embodiment of the present invention; and

FIG. 3 is a method of active airflow control for an aircraft, according to an exemplary embodiment of the present invention.

### DETAILED DESCRIPTION OF THE INVENTION

Passenger cabins in aircraft may be divided into a plurality of different zones. Each zone, under steady-state and changing circumstances, may have a minimum airflow requirement. According to exemplary embodiments of the present invention, a solution is provided which realizes active control of airflow to each zone of the plurality of zones, ensuring that minimum airflow requirements of each zone are met while limiting modulation of an auxiliary power unit powering an air conditioning system. The technical effects and benefits of exemplary embodiments include an increase in auxiliary power unit life expectancy and active control of airflow within aircraft.

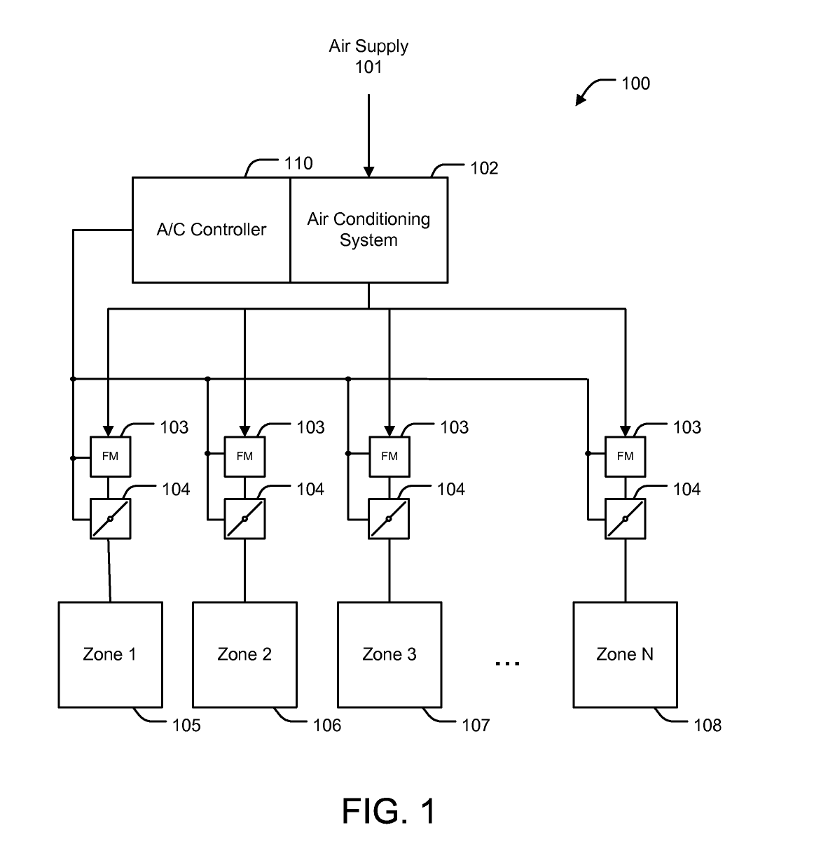

Turning to FIG. 1, a system of active airflow control for an aircraft is illustrated. The system 100 includes air supply 101. The air supply 101 may be a steady and/or compressed supply of air disposed to be dispersed within an aircraft's cockpit and passenger cabin. The system 100 further includes air conditioning system 102 in fluid communication with the air supply 101. The air conditioning system 102 may receive air from the air supply 101, condition the received air, and disperse the air to the aircraft's cockpit and passenger cabin. Furthermore, the air conditioning system 102 may include a controller portion 110 configured to control the air conditioning system 102. The controller portion 110 may include a computer processor, microprocessor, microcontroller, application-specific integrated circuit, or any other suitable controller configured to execute instructions or operations related to controlling the air conditioning system 102.

The system 100 further includes a plurality of flow measuring devices 103 (i.e., airflow feedback apparatuses) in fluid communication with the air conditioning system 102, and in signal communication with the controller portion 110. Each flow measuring device 103 may be a device configured to detect a rate or amount of air travelling therethrough, and relay the flow rate or amount of air to the controller portion 110. For example, the flow measuring devices 103 may be embodied as venturi devices or any similar devices disposed to detect a volume or flow rate of air passing proximate thereto.

The system 100 further includes a plurality of flow control devices 104 in fluid communication with the flow measuring devices 103 and the air conditioning system 102, and in signal communication with the controller portion 110. Each flow control device 104 may be a device configured to dampen or control a flow of air passing therethrough in response to a signal received from the controller portion 110. For example, the flow control devices 104 may be embodied as dampers, valves, or any similar devices disposed to control a flow of air passing therethrough.

As further illustrated, the system 100 includes a plurality of aircraft zones 105, 106, 107, and 108 in fluid communication with respective flow control devices 104 and flow measuring devices 103. Each zone of the plurality of aircraft zones 105-108 may be any pressurized area or portion of an aircraft (e.g., passenger cabin zones, flight deck compartment). Depending upon an air flow need of a particular zone, the controller portion 110 may receive a current flow of air through a flow measuring device 103 and further dampen or increase air flow to the particular zone through application of a control signal to a respective flow control device 104.

For example, if Zone 1 (105) requires a first amount of air flow, while Zones 2-N (106-108) require a second amount of air flow, the controller portion 110 may balance airflow through control of each individual flow control device 104 while receiving updated flow measurements from each individual flow measuring device 103. In this manner, the controller portion 110 can ensure that the first amount of air flow is actually provided to Zone 1 105 and the second amount of air flow is provided to all remaining zones while reducing the overall demand from the auxiliary power unit/engine powering the air conditioning system. Additionally, if the air conditioning system is operating with the engine as the air source, there will be a fuel burn benefit that would be realized.

Furthermore, the system 100 may continually rebalance airflow to each zone of the plurality of zones 105-108 depending upon control feedback provided to the controller portion 110. For example, occupant information may be updated at the controller portion 110 to represent a distribution of aircraft occupants within each zone. Thereafter, a minimum amount of air flow per occupant may be coordinated and calculated to determine minimum airflow requirements for each zone based on occupant distribution. Upon calculation of updated requirements, airflow to each aircraft zone may be balanced again to ensure all airflow requirements are met or exceeded. Accordingly, additional updates during aircraft operation are possible, for example when re-seating or re-distributing occupants, such that minimum airflow requirements are always ensured according to occupancy in each individual zone.

As described above, exemplary embodiments of the present invention provide systems for active airflow control in aircraft which are capable of determining and balancing airflow requirements across an entire pressurized section of an aircraft based on a plurality of aircraft zones. Each zone of the aircraft may include a flow measuring device and flow control device providing airflow measurements therefrom and controlling airflow thereto. Each flow measuring device and flow control device may be in signal communication with a controller portion of an air conditioning system of the aircraft, and the controller portion of the air conditioning system may interpret information provided by each flow measuring device, as well as aircraft cabin occupancy information, to determine and balance airflow to each aircraft zone while minimizing power cycling of the air conditioning system.

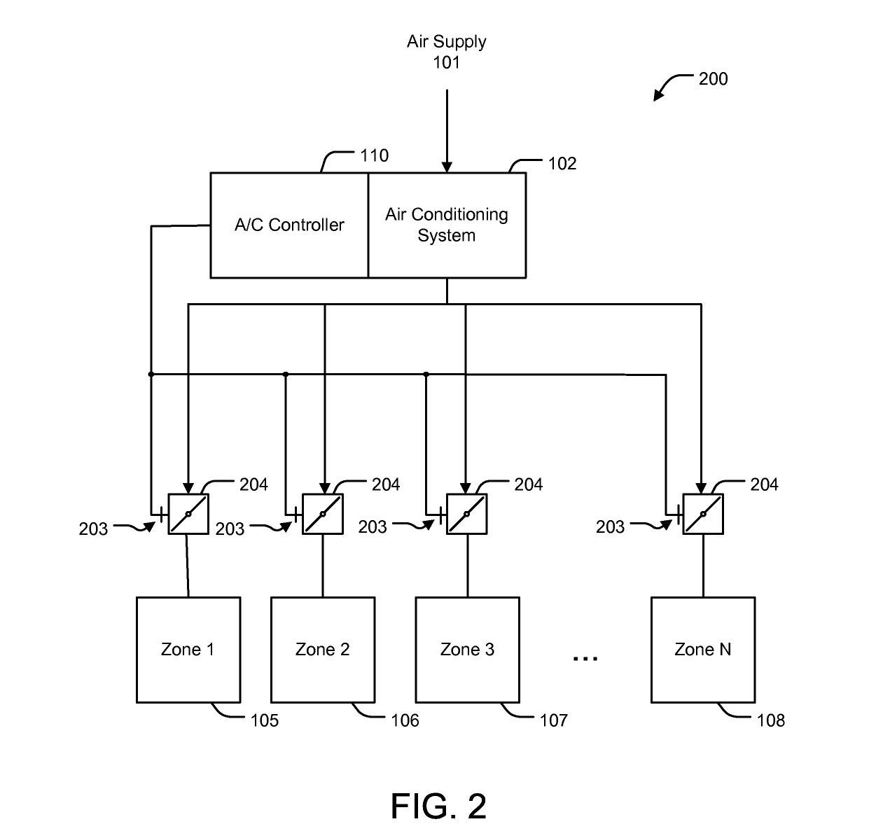

Although particularly described as separate and distinct devices, the flow measuring devices 103 and flow control devices 104 may be integrated into a singular device. Furthermore, mechanical position feedback may also be used to determine or infer airflow based on overall airflow provided from an air conditioning system. Therefore, individual flow measuring devices may be omitted if mechanical positions of flow control devices are available to a controller of an air conditioning system. For example, FIG. 2 illustrates an active airflow control system for an aircraft absent flow measuring devices.

Turning to FIG. 2, the system 200 may include the air conditioning system 102, controller portion 110, and plurality of zones 105-108. However, the system 200 includes a plurality of flow control devices 204 in fluid communication with each aircraft zone. Furthermore, each flow control device 204 includes flow control position feedback portions 203 configured to provide mechanical position information to the controller portion 110 (i.e., airflow feedback apparatuses). For example, mechanical position information may include a numerical value representing a mechanical position of the flow control device 204. The mechanical position may be a percent open, percent closed, a fixed numerical range representing a range of open or closed positions, or any other suitable mechanical position information. This mechanical position information may be provided to the controller portion 110.

Upon receipt of individual mechanical position information for each flow control device 204 controlling air flow to each individual zone of the aircraft, an amount of airflow per zone may be calculated based on a total airflow provided by the air conditioning system 102 in relation to the related positions of each flow control device. This information may be processed to determine appropriate mechanical positions for each flow control device 204 such that minimum airflow requirements are met for each individual zone. Furthermore, airflow to each zone may be balanced and rebalanced as described above, to adapt to changing occupancy information for each zone.

In this manner, the system 200 may be controlled somewhat similarly to system 100, thereby providing active control of airflow while reducing power cycling and modulation of the air conditioning system 102.

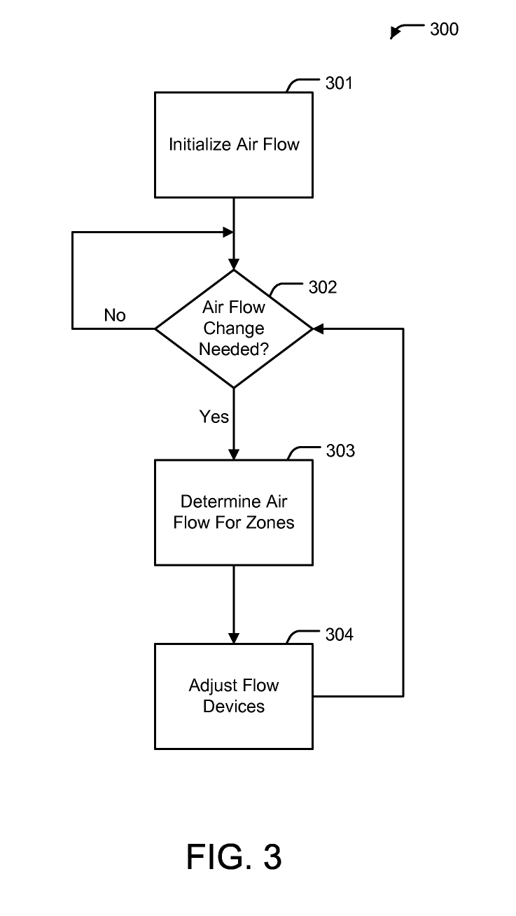

Hereinafter, a method of active airflow control for an aircraft is described with reference to FIG. 3.

FIG. 3 illustrates a flowchart of a method of active airflow control for an aircraft, according to an exemplary embodiment of the present invention. The method 300 includes initializing airflow to a pressurized portion of an aircraft at block 301. Initializing the airflow includes powering on or initializing an air conditioning system 102 such that supply air is received, conditioned, and dispersed to the pressurized portion of the aircraft. As stated above, the pressurized portion of the aircraft is divided into a plurality of different zones.

Subsequently, the method 300 includes determining if a change in airflow is needed at block 302. Determining if the change is needed may include determining if an occupant count for a particular aircraft zone has changed. Determining if the change is needed may also include determining if occupant distribution across aircraft zones has changed. Determining if the change is needed may also include determining if a minimum airflow requirement has been disrupted based on airflow being redirected to a different zone (e.g., for airflow balancing). Furthermore, determining if the change is needed may include any combination of the above examples, such that overall balancing may be established for continually changing conditions within the aircraft.

Subsequent to determining a change in airflow is not needed, the method 300 loops and continues to monitor airflow needs, changes, and shifts at block 302.

Subsequent to determining a change in airflow is actually needed, the method 300 includes determining airflow requirements for each zone of the aircraft at block 303. Determining airflow requirements may include receiving airflow information from a plurality of flow measuring devices measuring airflow to each individual zone, determining a minimum airflow for each individual zone based on occupancy information for the aircraft, and determining a change to airflow for each zone based on the received flow information and the occupancy information. For example, a minimum amount of airflow may be established for each occupant. This minimum airflow may be a predetermined value of airflow per occupant established or regulated by a regulatory body. Further, the airflow per occupant may be extrapolated across individual zones based on a number of occupants in each zone to determine the minimum airflow required for each zone. This minimum airflow for each zone may be compared to the received airflow information to determine if an increase or decrease in airflow is necessary.

Upon determining airflow requirements for each zone, the method 300 includes adjusting flow control devices to match or exceed the airflow requirements at block 304. Adjusting flow control devices may include directing particular flow control devices to increase or decrease airflow to an associated zone, for example, by opening or closing each flow control device by a specified amount required to achieve the desired or minimum airflow, or to exceed the airflow requirements.

As described above, systems and methods of active airflow control for aircraft are provided which realize active control of airflow to each zone of a plurality of aircraft zones, ensuring that minimum airflow requirements are met while limiting modulation (e.g., powering on-off) of an auxiliary power unit powering an air conditioning system.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An active airflow control system for an aircraft, comprising:
an air conditioning system;
an air conditioning controller configured to control operation of the air conditioning system;
a plurality of flow control devices in fluid communication with the air conditioning system and in signal communication with the air conditioning controller, wherein the plurality of flow control devices are configured to increase and decrease an amount of air flowing therethrough in response to receiving a controlling signal from the air conditioning controller; and
a plurality of zones in fluid communication with the air conditioning system, wherein each zone of the plurality of zones is a pressurized zone of the aircraft, and wherein each zone of the plurality of zones is in fluid communication with at least one flow control device of the plurality of flow control devices.

2. The system of claim 1, further comprising:
a plurality of airflow feedback apparatuses in communication with the plurality of flow control devices and in signal communication with the air conditioning controller.

3. The system of claim 2, wherein the plurality of airflow feedback apparatuses are flow measuring devices configured to measure an amount of air flowing therethrough.

4. The system of claim 3, wherein the plurality of flow measuring devices are venturi devices.

5. The system of claim 2, wherein the plurality of airflow feedback apparatuses are mechanical position feedback apparatuses configured to determine a mechanical position of an associated flow control device of the plurality of flow control devices.

6. The system of claim 1, wherein the air conditioning system is in fluid communication with an air supply, the air conditioning system being configured to disperse the supply of air into the plurality of zones.

7. The system of claim 1, wherein the air conditioning controller is configured to balance airflow across the plurality of zones in response to occupancy information of each zone of the plurality of zones.

8. The system of claim 1, wherein the air conditioning controller is configured to increase and decrease airflow to each zone of the plurality of zones in response to an increase and decrease of a number of occupants within each zone of the plurality of zones.

9. The system of claim 1, wherein the air conditioning controller is configured to direct each flow control device of the plurality of flow control devices to provide a minimum amount of air flow to an associated zone of the plurality of zones.

10. The system of claim 9, wherein the air conditioning controller is configured to determine the minimum amount of air flow for each associated zone based on a number of occupants in each associated zone.

11. A method of active airflow control in an aircraft, comprising:
initializing airflow to a plurality of zones in an aircraft, wherein the initializing of the airflow includes initializing a plurality of flow control devices in fluid communication with each zone of the plurality of zones;
determining if a change in airflow is required in at least one zone of the plurality of zones;
determining airflow requirements for each zone of the plurality of zones responsive to determining a change in airflow is required for the at least one zone; and
adjusting the plurality of flow control devices to match or exceed the airflow requirements.

12. The method of claim 11, wherein initializing the airflow further includes initializing an air conditioning system for the aircraft, the air conditioning system being configured to provide airflow dispersal to the plurality of zones.

13. The method of claim 11, wherein determining if the change in airflow is needed comprises:
determining if an occupant count for the at least one zone has changed.

14. The method of claim 11, wherein determining if the change in airflow is needed comprises:
if occupant distribution across the plurality of zones has changed.

15. The method of claim 11, wherein determining if the change in airflow is needed comprises:
determining if a minimum airflow requirement for the at least one zone has been disrupted.

16. The method of claim 15, wherein determining if a minimum airflow requirement has been disrupted includes receiving airflow information from an airflow feedback apparatus of the at least one zone.

17. The method of claim 11, wherein adjusting the plurality of flow control devices comprises directing each flow control device of the plurality of flow control devices to increase or decrease airflow to an associated zone based on the airflow requirements.
